(19) United States
(12) Patent Application Publication
(10) Pub. No.: US 2020/0200285 A1
(43) Pub. Date: Jun. 25, 2020

(54) VALVE FOR A HEAT-TRANSFER FLUID CIRCUIT

(71) Applicant: SCHRADER, Pontarlier (FR)

(72) Inventor: Adrien PERET, Pontarlier (FR)

(21) Appl. No.: 16/629,138

(22) PCT Filed: Jun. 28, 2018
(86) PCT No.: PCT/FR2018/051598

§ 371 Date: Jan. 7, 2020

(30) Foreign Application Priority Data
Jul. 7, 2017 (FR) 1756475

(51) Int. Cl. F16K 15/06; F16K 27/02

(52) U.S. Cl. CPC F16K 15/063; F16K 15/026; F16K 27/0209

(57) ABSTRACT

A valve for a heat-transfer fluid circuit having a valve body defining a passage and having a proximal end and a distal end. The valve includes a valve mechanism positioned in the passage, the valve mechanism including a valve head and a seat arranged so as to engage sealingly with each other, the seat being arranged on the valve body in the passage.

### RELATED APPLICATIONS

This present application is a National Phase entry of PCT Application No. PCT/FR2018/051598 filed Jun. 28, 2018 which claims priority to French Application No. 1756475 filed Jul. 7, 2017, the contents of each being incorporated herein by reference in their entireties.

### TECHNICAL FIELD

The invention relates to the field of valves for a fluid circuit subjected to pressurized environments, and the like such as a charging valve, a pressure relief valve, a check valve, and for example a valve for a heat-transfer fluid circuit. Embodiments of the invention apply more particularly to a charging valve for a heat-transfer fluid circuit.

BACKGROUND ART

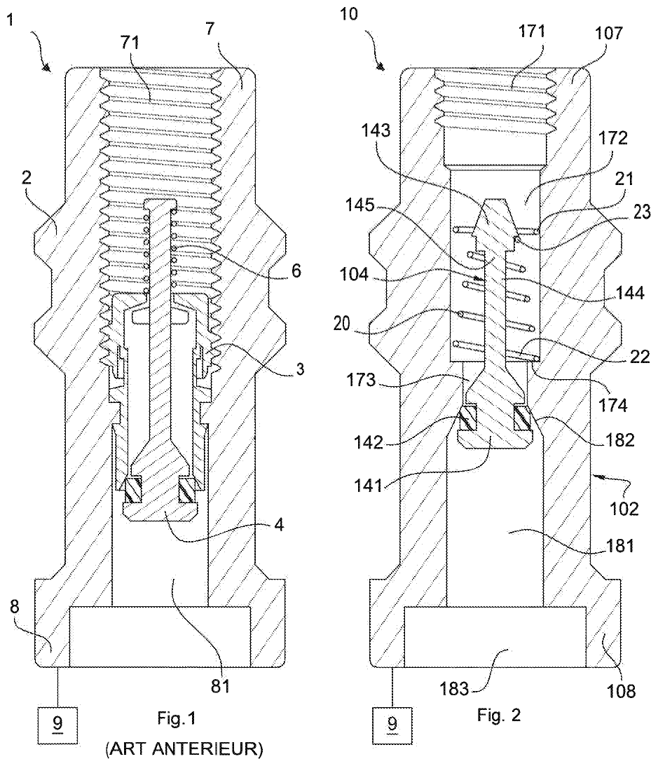

Currently, the valves for a heat-transfer fluid circuit, for example of an air conditioner, such as the valve 1 illustrated in FIG. 1, are at least in two portions which are the valve body 2 and the valve mechanism 3, 4, 6. The valve mechanism includes a shutter 4 and the associated seat thereof which is made in a conduit made in a mechanism body 3. The mechanism body 3 is mounted attached, in a screwed manner, at the distal end 7 of the valve body 2, a distal end 7 which includes to this end a threaded distal passage portion 71. The valve mechanism is then in the passage of the valve body 2, between a distal passage portion 71 and a proximal passage portion 81 leading to a distal end 8 of the valve body.

However, in operation, an air conditioning circuit is subjected to strong thermal variations, thermal variations to which are consequently subjected the valve body and the elements of the valve mechanism, including the mechanism body. Their differences in size and material composition lead to different thermal inertia, at least between the two valve and mechanism bodies. Consequently, during thermal variations of the air conditioning circuit, the valve and mechanism bodies expand (or contract) in different manners, which leads to a loosening of the mechanism body within the valve body. There is then a leakage which settles which is detrimental to the proper operation of the air conditioning circuit.

### SUMMARY

A purpose of embodiments of the invention is to provide a valve for a heat-transfer fluid circuit, such as an air conditioning circuit, which is simple and impervious to the thermal variations of such a circuit.

To this end, there is provided, according to embodiments of the invention, a valve for a heat-transfer fluid circuit including a valve body defining a passage and having a proximal end and a distal end, a valve mechanism positioned in the passage, the valve mechanism including a shutter and a seat arranged so as to sealingly cooperate with each other, in addition, the seat being arranged on the valve body in the passage.

Thus, by providing the seat of the valve mechanism on the valve body, it is no longer necessary to have an attached mechanism body, since thereby the valve body acts as a mechanism body. Consequently, the risk of loosening due to thermal variations of the heat-transfer fluid circuit is eliminated.

Advantageously, but optionally, the valve according to embodiments of the invention has at least one of the following additional technical characteristics:

the valve mechanism comprises means for controlling the shutter located at the distal end of the valve body;

the valve mechanism includes a shutter rod comprising a head forming the shutter including a sealing gasket arranged so as to sealingly cooperate with the seat of the valve body;

the valve mechanism includes a shutter rod comprising a head forming the shutter arranged so as to sealingly cooperate with a sealing gasket arranged on the seat of the valve body;

the valve mechanism includes return means in the closed position located at the distal end of the valve body;

the return means comprise a spring;

the spring includes, at one end, a first coil bearing on a bearing rim of the valve body in the passage and, at one opposite end, a coil in connection with the shutter and an enlarged guiding and stabilization coil;

the shutter rod includes a bulge cooperating with the coil;

the valve is a charging valve of an air conditioning circuit.

the bulge is formed by at least two spoilers forming part of a cone or truncated cone made at the ends of two arms forming the rod and separated by a longitudinal slot.

the bulge is made by a crimping operation on the shutter rod.

the bulge comprises a part attached on the shutter rod.

Other characteristics and advantages of embodiments of the invention will become apparent during the following description of a preferred embodiment. In the appended drawings:

FIG. 1 is a cross section view of a valve for a heat-transfer fluid circuit of the prior art;

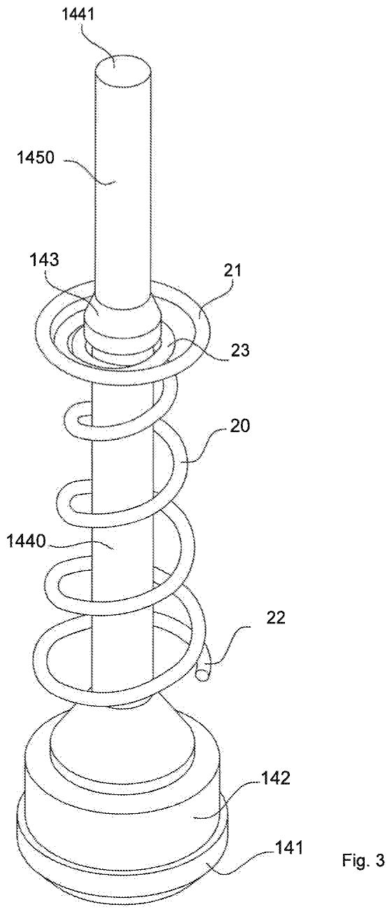

FIG. 2 is a cross section view of a valve for a heat-transfer fluid circuit according to an embodiment of the invention;

FIG. 3 is a three-dimensional view of the assembly of the shutter rod, according to one variant embodiment thereof, and of the return means;

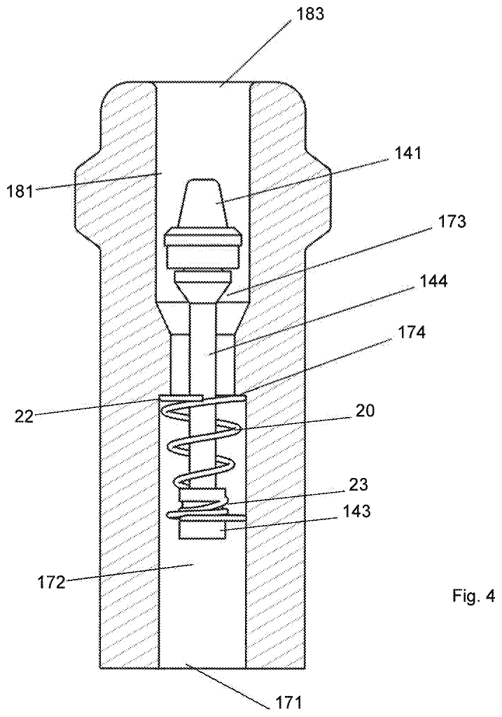

FIG. 4 is a cross section view of a second embodiment of the valve according to the invention; and

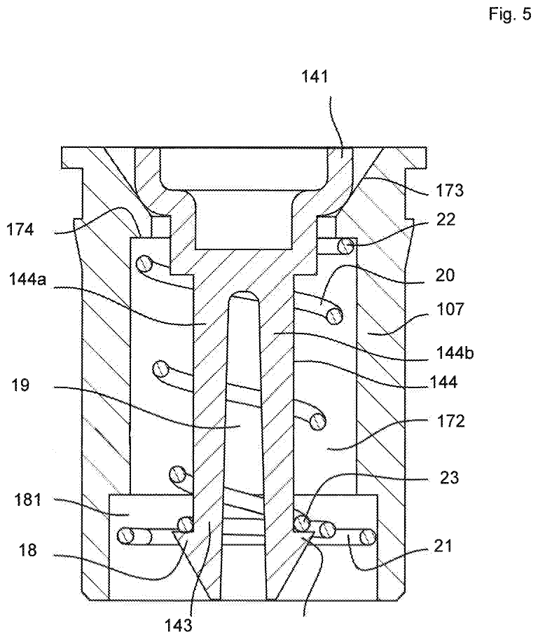

FIG. 5 is a cross section view of a third embodiment according to the invention

### DETAILED DESCRIPTION

With reference to FIG. 2, an embodiment of a valve 10 according to an embodiment of the invention intended to be mounted on a heat-transfer fluid circuit, such as an air conditioning circuit, will be described. The heat-transfer fluid circuit includes at least one conduit section 9, schematized in the figures by a simple rectangle connected to the valve 10 according to an embodiment of the invention. The valve 10 according to an embodiment of the invention includes a valve body 102 which defines a passage 171, 172, 173, 181, 183, here having a cylindrical shape of revolution of axis the longitudinal axis of the valve 10 according to an embodiment of the invention. The passage 171, 172, 173, 181, 183 extends from a distal end 107 of the valve 10 according to the invention, to a proximal end 108 of the valve 10 according to an embodiment of the invention. It includes successively from the distal end 107 to the proximal end 108:

an inlet 171; then,

a distal portion 172; then,

a central portion 173 having a diameter less than a diameter of the distal portion 172 and connected to the latter by a bearing rim 174; then,

a proximal portion 181 of a larger diameter than that of the inner portion 173 and connected thereto by a frusto-conical seat 182; then

an outlet 183 which opens into the heat-transfer fluid circuit, during mounting of the valve 10 according to an embodiment of the invention on the conduit 9, this mounting being able to be carried out at an end of the conduit 9 or through a side wall of the conduit or else be formed integrally with said conduit 9 or any other component of the heat-transfer fluid circuit.

The valve 10 according to an embodiment of the invention further includes a valve mechanism 104 positioned in the passage 171, 172, 173, 181, 183. The valve mechanism 104 includes a shutter rod 144. The shutter rod 144 comprises a head forming a shutter 141 on which is arranged a sealing gasket 142. Once the valve mechanism 104 is in place in the valve body 102, the sealing gasket 142 bears on the seat 182 of the passage 171, 172, 173, 181, 183, the valve mechanism 104 then being in a closed position preventing at least heat-transfer fluid leakage from the proximal portion 181 of said passage, a closed position ensured by return means 20 including, here, a spring. The sealing gasket 142 is made of a thermosetting, vulcanizable or injectable polymer, or else of a metal, without this being exhaustive. In a variant embodiment, the sealing gasket 142 is formed integrally with the head forming a shutter 141. According to another variant embodiment, the sealing gasket is arranged on the seat 182.

Once mounted in the passage 171, 172, 173, 181, 183, the valve mechanism 104 has the head 141 of the shutter rod 144 positioned in the proximal portion 181 of the passage 171, 172, 173, 181, 183, a tail 145 of the shutter rod 144 passing through the central portion 173 to extend into the distal portion 172 in which are located the return means 20. In addition, the tail 145 of the shutter rod 144 includes a bulge 143 located in the distal portion 172, here forming a free end of the tail 145. The tail 145 of the shutter rod 144 and the return means 20 form means for controlling the shutter. More specifically, the spring forming the return means 20 has for example a generally cylindro-conical shape. It comprises a first coil 22 forming a large base and having a diameter substantially identical to the diameter of the distal portion 172. This first coil 22 is bearing on the bearing rim 174 connecting the distal portion 172 of the passage 171, 172, 173, 181, 183 to the central portion 173 of the latter. The spring further includes a coil 23 forming the small base. The coil 23 bears on the tail 145 bulge 143 of the shutter rod 144. When the spring is mounted on the shutter rod 144, the bulge 143 is force-fitted through the coil 23. The coil 23 is concentrically extended by an enlarged coil 21 whose diameter is substantially identical to the diameter of the distal portion 172. This enlarged coil 21 is a coil for centring and radially stabilizing the shutter rod 144 in the distal portion 172 of passage 171, 172, 173, 181, 183.

The valve mechanism 104 is more fully described in document WO 2016/174323, incorporated herein by reference and to which reference can be made for more detailed information.

In FIG. 3, a variant embodiment 1040 of the valve mechanism of a valve 10 has been illustrated according to an embodiment of the invention. This valve mechanism 1040 is very similar to the valve mechanism 104 previously described. The valve mechanism 1040 includes a shutter rod 1440. The shutter rod 1440 comprises a head forming a shutter 141 on which is arranged a sealing gasket 142. As before, once the valve mechanism 1040 is in place in the passage of the valve body of the valve 10 according to an embodiment of the invention, the sealing gasket 142 bears on the seat 182 of the passage 171, 172, 173, 181, 183, the valve mechanism 1040 then being in a closed position preventing at least heat-transfer fluid leakage from the proximal portion 181. This closed position of the valve mechanism 1040 is ensured by the return means 20 previously described. Similarly to the embodiment of FIG. 2, once mounted in the passage 171, 172, 173, 181, 183, the valve mechanism 1040 has the head 141 of the shutter rod 1440 positioned in the proximal portion 181 of the passage 171, 172, 173, 181, 183, a tail 1450 of the shutter rod 1440 passing through the central portion 173 to extend into the distal portion 172 in which are located the return means 20. The tail 1450 of the shutter rod 1440 includes the bulge 143 located in the distal portion 172, at a distance from a free end 1441 of the tail 1450. The tail 1450 of the shutter rod 1440 and the return means 20 form means for controlling the shutter.

According to one embodiment of the invention, the bulge 143 is made by a crimping operation on the shutter rod 1440. The crimping operation can be carried out before or after mounting the shutter rod 1440 in the valve body 102.

Similarly, according to another variant embodiment, the bulge 143 can be obtained by means of a part attached on the shutter rod 1440. The assembly of this attached part forming the bulge 143 on the shutter rod 1440 is carried out for example by brazing, welding, screwing or crimping.

Such a structure allows positioning the sealing portion formed by the head 141 (and the sealing gasket 142 thereof) and the seat 182 anywhere within the passage 171, 172, 173, 181, 183 of the valve 10 according to embodiments of the invention, while ensuring compliance with the standard distance between the free end 1441 of the shutter rod 1040 and the inlet 171 of the distal end 107.

FIG. 4 shows a second embodiment of the valve according to an embodiment of the invention identical in every way to the embodiment shown in FIG. 2, apart from the fact that the valve mechanism 104 is in a normal open position to ensure the fluid communication from the proximal portion 181 of said passage. The maintaining in the open position is ensured by return means 20 also including a spring.

According to the exemplary embodiment shown in FIG. 5, this embodiment differs from the previous ones in that the bulge 143 is formed by at least two spoilers 17,18 forming part of a cone or truncated cone made at the ends of two arms 144a, 144b forming the rod 144, separated by a longitudinal slot 19, so as to make them elastically deformable and allow mounting or dismounting, relative to the small base 23 of the spring 20. The connection between the tail of the shutter rod 144 and the end coil 23 constituting the small base of the spring 20 is then performed by the spoilers 17, 18.

It should also be noted that such a valve structure 10 according to embodiments of the invention allows making a valve body 102 which has a distal portion 172 whose diameter is smaller than the diameter necessary to make the tapping for receiving a valve mechanism according to the prior art, since the thread depth of said tapping (which has become unnecessary) is recovered to obtain a significantly greater material thickness at the distal portion 172, therefore an increased mechanical resistance.

Secondarily, such a valve structure 10 according to embodiments of the invention allows increasing the possible flow rates of the heat-transfer fluid charge and/or discharge due to the absence of a screwed valve mechanism of the prior art which reduces the passage in the valve body.

In addition, such a valve structure 10 according to embodiments of the invention allows eliminating the risk of introducing wear debris or shavings into the heat-transfer fluid circuit, risks which are detrimental to the operation of said circuit and which could occur during screwing of a valve mechanism according to the prior art in the tapping for receiving the valve body. Thus, the valve 10 assembly cleanliness according to the invention is ensured.

On the other hand, such a valve structure 10 according to embodiments of the invention allows dispensing with the clamping stresses necessary for the valve mechanism of the prior art.

This allows making a valve body in a wide range of materials such as, for example, metal (aluminium, brass, steel, stainless steel, . . . ) or a thermosetting, vulcanizable or injectable polymer (polyamide, polyoxymethylene, phenylene polysulphide, polyphthalamide, polyimide, polyamide-imide, etc.) which is charged or not, without this being exhaustive.

Once in place in a heat transfer fluid circuit, the valve 10 according to embodiments of the invention guarantees a non-dismountability, in particular of the valve mechanism. This ensures a high safety, regardless of the material(s) used to make the valve 10 according to embodiments of the invention.

The valve 10 according to embodiments of the invention can be mounted attached to an end of the conduit 9 or on a side wall of the conduit. It may also be formed integrally with said conduit 9 or any other component of the heat-transfer fluid circuit.

Of course, it is possible to make various modifications to the invention without departing from the scope thereof.

1. A valve for a heat-transfer fluid circuit including a valve body defining a passage and having a proximal end and a distal end, a valve mechanism positioned in the passage, the valve mechanism including a shutter and a seat arranged so as to sealingly cooperate with each other, the seat being arranged on the valve body in the passage, characterised in that the valve mechanism includes return means located at the distal end of the valve body and a shutter rod comprising a head forming the shutter, the shutter rod including a bulge cooperating with the return means.

2. The valve according to claim 1, wherein the valve mechanism comprises means for controlling the shutter located at the distal end of the valve body.

3. The valve according to claim 1, wherein the shutter rod comprises a head forming the shutter) including a sealing gasket arranged so as to sealingly cooperate with the seat of the valve body.

4. The valve according to claim 1, wherein the shutter rod comprises a head forming the shutter) arranged so as to sealingly cooperate with a sealing gasket arranged on the seat of the valve body.

5. The valve according to claim 1, wherein the return means comprise a spring.

6. The valve according to claim 5 wherein the spring includes, at one end, a first coil bearing on a bearing rim of the valve body in the passage and, at one opposite end, a coil in connection with the shutter rod and an enlarged guiding and stabilisation coil.

7. The valve according to claim 3, wherein the bulge of the shutter rod cooperates with the coil.

8. The valve according to one of claim 1, wherein it is a charging valve of an air conditioning circuit.

9. The valve according to one of claim 1, wherein the return means maintain the shutter rod in the closed position.

10. The valve according to one of claim 1, wherein the return means maintain the shutter rod in the open position.

11. The valve according to one of claim 1, wherein the bulge is formed by at least two spoilers forming part of a cone or truncated cone made at the ends of two arms forming the rod and separated by a longitudinal slot.

12. The valve according to claim 1, wherein the bulge is made by a crimping operation on the shutter rod.

13. The valve according to claim 1, wherein the bulge comprises a part attached on the shutter rod.
